(19) United States
(12) Patent Application Publication
(10) Pub. No.: US 2009/0319321 A1
(43) Pub. Date: Dec. 24, 2009

(54) SYSTEMS AND METHODS FOR SCHEDULING INSTRUCTIONAL COURSES HAVING ASSOCIATED COMPLIANCE RULES

(75) Inventors: Justin Arthur Pruskowski, Woodinville, WA (US); Douglas Alan Crow, Issaquah, WA (US)

Correspondence Address: DORSEY & WHITNEY LLP;INTELLECTUAL PROPERTY DEPARTMENT, SUITE 3400, 1420 FIFTH AVENUE, SEATTLE, WA, 98101, US

(73) Assignee: The Driver Training Group, Inc., Redmond, WA (US)

(21) Appl. No.: 12/145,312

(22) Filed: Jun. 24, 2008

(51) Int. Cl. G06Q 10/00; G06F 17/30

(52) U.S. Cl. 705/8

(57) ABSTRACT

Embodiments of the present invention provide methods and systems for scheduling an instructional course for a student where the instructional course requires completion of a plurality of events in accordance with at least one rule associated with a regulatory authority. Students may advantageously be shown a set of available events with an indication that certain events are compliant with the rules of the regulatory authority. Following completion of the required events, compliance information may be transmitted to the regulatory authority. Further, access may be provided to one or more student accounts for auditing purposes.

### TECHNICAL FIELD

Embodiments of the invention relate to scheduling of instructional courses having associated compliance rules, such as driver training courses.

### BACKGROUND OF THE INVENTION

Instructional courses may require completion of a variety of events—including classroom and lab sessions. For example, drivers training classes may require completion of classroom, laboratory, observation, and online or simulation sessions.

Many instructional courses require these disparate events to be completed in a particular order. Only after completing the events in a specific order is the student eligible for a final certification—a degree or a license, for example. For example, to obtain drivers certification, a complex set of requirements may be imposed requiring, for example, a lab session to be completed within a specific window after certain classroom sessions have been completed.

Existing training courses typically leave compliance with these complex rules up to the individual student. The student themselves is responsible for ensuring the events are completed in an appropriate order to obtain certification. Other courses attempt to track compliance with the governing rules separately, for example in an Excel spreadsheet, charting a student's progress. These systems suffer from inaccurate reporting of the student's information, and the requirement that the student themselves become intimately familiar with the compliance rules for their instructional course in their jurisdiction. Inaccurate understanding of the rules, or inaccurate reporting into an Excel spreadsheet, causes extra time to be spent determining compliance information, or may cause students to fail to comply even after completing many requirements.

Accordingly, there is a need for a better method of ensuring students complete instructional courses in compliance with the requirements of a regulatory authority for the course.

### BRIEF DESCRIPTION OF THE DRAWINGS

FIG. 1 is a flow diagram of a method according to an embodiment of the present invention.

FIG. 2 is an example of information that may be shown to a student according to an embodiment of the present invention.

FIG. 3 is a schematic diagram of a system according to an embodiment of the present invention.

### DETAILED DESCRIPTION

Embodiments of the present invention provide methods and systems for scheduling an instructional course for a student where the instructional course requires completion of a plurality of events in accordance with at least one rule associated with a regulatory authority. Certain details are set forth below to provide a sufficient understanding of embodiments of the invention. However, it will be clear to one skilled in the art that embodiments of the invention may be practiced without various of these particular details. In some instances, well-known computer system architectures, circuits, control signals and software operations have not been shown in detail in order to avoid unnecessarily obscuring the described embodiments of the invention.

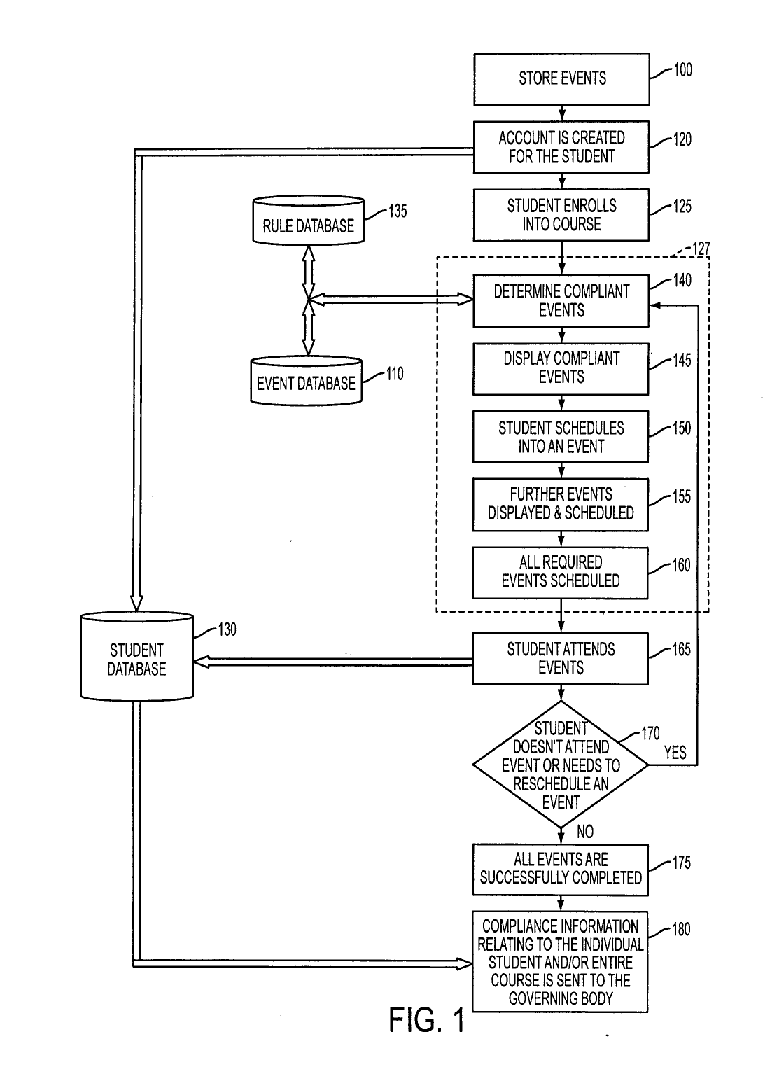

FIG. 1 is a flowchart of a method according to an embodiment of the present invention. A plurality of event records are stored 100 in an event database 110. Each event record represents an event—an activity that may be part of a larger course. Events corresponding to any number of courses may be stored in the event database. Events may pertain to only one course, or may be associated with multiple courses. The event record generally includes information about a type of the event, a time and place of the event, and a capacity of the event. Types of events may include, for example, a class where a plurality of students, such as 10 to 30 students are together for shared learning with an instructor. Another type of event may be a lab where a number of students, for example 1 to 2 students are together for personalized learning practicing an action that the instructional course is designed in part to teach. Another type of event may be an observation where a student observes the event and provides or hears feedback as a method of learning. Another type of event may be an online event, such as a computer implemented instruction or course that a student can go through at their own pace or at a predetermined pace. Another type of event may be a simulation where an action the student will be learning is simulated for observation or participation, or both, by the student.

Each event record may include an indication of capacity limit as to number of students per event. Event records may further include requirements for the availability of an instructor and availability of other resources such as location, equipment or the like. The event records are stored in the event database 110. The records may be created by a database administrator, other personnel, or by a computer program. Any type of database may be used to implement the event database 110 and any type of communication medium, wired or wireless, may be used to interact with the event database 110.

An account is created 120 for each student. The account is stored as a record in student database 130. As with the event database, student account records may be created by a database administrator, other personnel, students, or by a computer program. Each student may be identified by a unique identification number or the like and biographical information may be stored in each account in the student database 130.

Referring again to FIG. 1, a student enrolls 125 into a course. A student may be enrolled by an administrator or by themselves signing up for the course. Recall each course requires completion of a plurality of events according to certain rules. The rules may specify which events or event types must be completed before others, and the rules may differ according to regulatory authorities. For example, a driver training course in California may have different rules for the completion of events than a driver training course in Washington. Accordingly, rules may differ by state, county, educational institution, or other regulatory authority. Examples of regulatory authorities may include government entities, instructional institutions, or any other entity responsible for course compliance including state departments of licensing, the National Association of State Boards of Accounting or other overseeing body.

Rules may also differ according to some other category—subject matter or license sought, for example. Rules governing available courses may be stored in a rule database 135. Rules may include prerequisites—such as Class A must be completed before Lab B, timing requirements—Class A must be completed within X days of Lab B, quantity requirements—5 classes and 2 labs must be completed, and the like. Any rule concerning the events may be stored in the rule database 135.

Although shown separately in FIG. 1, the rule, event and student databases 110, 130, 135 may each be implemented as separate databases or one or more of the databases may be co-located within a same database or memory structure.

Once a student enrolls 125 in a course, for example by selecting a particular course electronically or otherwise, partially or completely paying for a course, or other indication, a student will schedule into one or more events necessary or desirable for completion of the course. Accordingly, the actions 100, 120 and 125 in FIG. 1 may be performed prior to scheduling a student into events.

The method of FIG. 1 proceeds with a computer-implemented method 127 for scheduling the instructional program into which the student enrolled. The computer-implemented method 127 begins by accessing the rule database 135 and the event database 110 to determine 140 compliant events for the student's course. In some embodiments, the student database 130 is also accessed to determine 140 compliant events based on events the student may have already attended or scheduled. Compliant events include events that the student could take without violating any rules set by a regulatory authority associated with the course in which the student has enrolled 125.

For example, in one embodiment for scheduling a driver training course, the student enrolls in a driver training course and is given a schedule of fifteen classroom events on enrollment. The student must then schedule laboratory events (drives). The computer-implemented method determines 140 that a first drive must be completed after the third class but before the seventh class according to a rule in the rule database 135. Accordingly, only drive events stored in the event database 110 occurring between the student's scheduled third and seventh classes are displayed 145. Other rules for the drives may also be found in the rule database 135 such as a maximum of two drives scheduled on the same day or drives must be scheduled 48 hours apart. The rule database 135 may combine rules from a licensing entity and from an instructional institution. For example, the licensing agency may require a student participate in no more than two drives per day and the instructional institution may require a student's drives to occur 48 hours apart. Both rules may be in the rule database 135 and accessed to determine compliant events 140. Other rules may govern the availability of courses, such as requirements on instructor or resource availability.

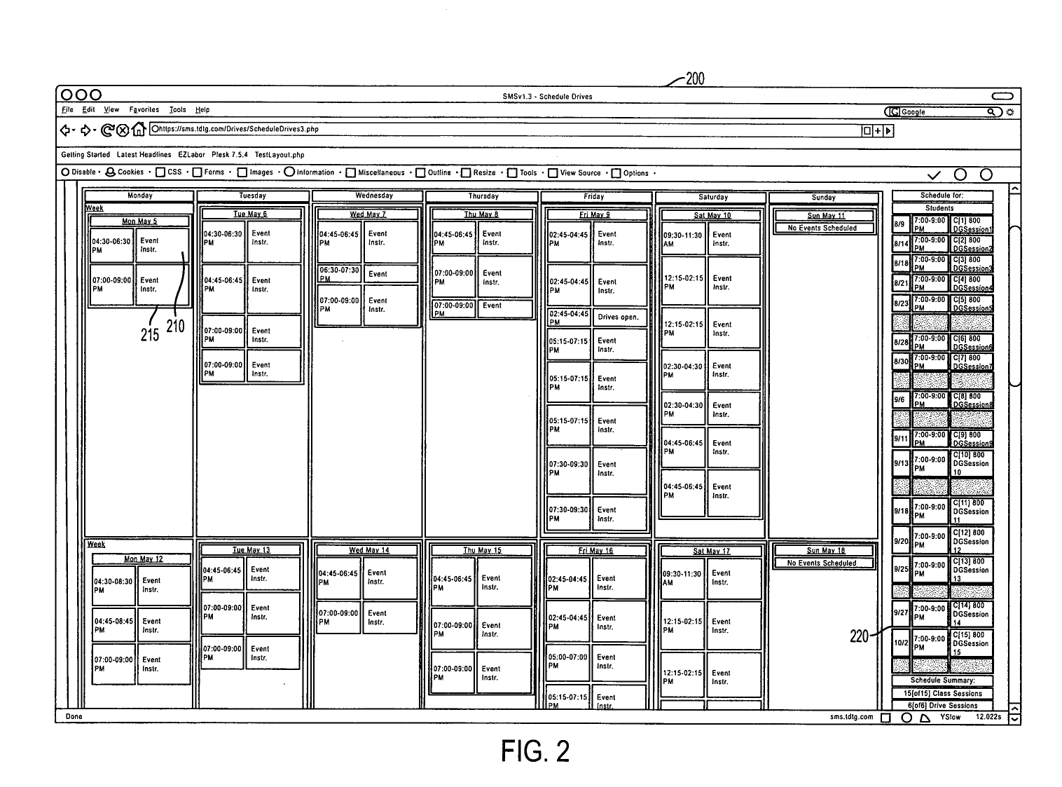

Instructions are sent for display 145 of compliant events to a student. The display may be a local or remote display. Any form of communication medium, wired or wireless may be used. In some embodiments, only information regarding the compliant events is displayed to the student. In some embodiments, simply displaying the event indicates to the student the event is compliant. In other embodiments, more than only the compliant events are transmitted for display and an indication is provided that certain of the events are compliant. An example of events displayed to a student is shown in FIG. 2. Operating over the Internet in the embodiment shown in FIG. 2, the student views displayed events in a browser window 200. Compliant events such as events 210, 215 are displayed in a calendar format. The time and date of each event are listed along with an event name (“Event” in FIG. 2) and instructor name (“Instr.” in FIG. 2). A student's complete schedule 220 may also be displayed alongside the available events, as shown in FIG. 2. The particular display shown in FIG. 2 is intended as an example of one embodiment of displaying compliant events and a student's schedule. In other embodiments, other methods of display may be used or the display may be arranged in a different format.

Referring back to FIG. 1, a request may then be received to schedule 150 the student into a particular event displayed. For example, a student or scheduler may click on an event in the display 200 of FIG. 2 or otherwise indicate their event selection. Because only compliant events were displayed or the compliant events were indicated, the student or scheduler can be certain that the event scheduled will meet the compliance rules for the course in which the student enrolled. In some embodiments, the student's record in the student database 130 is updated to reflect the student has been scheduled into the event in step 150.

Further events may be displayed and scheduled 155. For example, after scheduling into an event at step 150, the rule, event and student databases 110, 135, 130 may again be accessed to determine a new set of compliant events taking into account the scheduling of the event in step 150. That is, events may now be compliant that are required to be completed after completion of the event scheduled in 150 if they occur after the scheduled event in 150.

The process of accessing the rule and event databases, displaying compliant events, and scheduling the student into a compliant event continues until all required events for the enrolled course are scheduled 160. In other embodiments, a student may not be required to schedule all required events at once.

As the student attends events, a record of attendance is created in the student database 130 and associated with the student's account. In other embodiments, attendance records may be stored separately from the student database 130.

If a student does not attend an event or requests to reschedule an event 170, the scheduling process in steps 140-160 may be used to reschedule the events for the course. Once all required events are completed 175, compliance information may be sent 180 to or retrieved by, or both, an entity governing the course, such as an entity charged with ensuring compliance with rules stored in the rules database 110. The compliance information is obtained in part from the student database 130 containing the attendance records of the student. Because the scheduling program has ensured the student is scheduled into compliant events, reporting compliance information to the regulatory authority is simplified.

Furthermore, the regulatory authority or representatives or computer programs under the control of the regulatory authority, may be provided access to one or more of the student, event and rule databases. For example, a regulatory authority may access student records to confirm compliance information or verify the information is being accurately recorded. Furthermore, a regulatory authority may in some embodiments be given access to the rule database to update or replace rules associated with the regulatory authority. Access control to all or portions of one or more of the databases may be implemented in accordance with any available security methodology as known in the art.

The above description has considered a process for a student enrolling into, scheduling and completing a course. The rule, event and student databases 110, 135 and 130 may support scheduling and compliance reporting for more than one course. Accordingly, each time a student enrolls into a course, the student may be associated with a regulatory authority providing rules for the course. The computer-implemented method 127 accesses rules in the rule database 135 particular to the regulatory authority and determines compliant events accordingly. If a second student enrolls in a course associated with a second regulatory authority, the computer-implemented method 127 may access rules pertinent to the second regulatory authority in the rule database 135, potentially resulting in display of a different set of compliant events based on the second accessed rule.

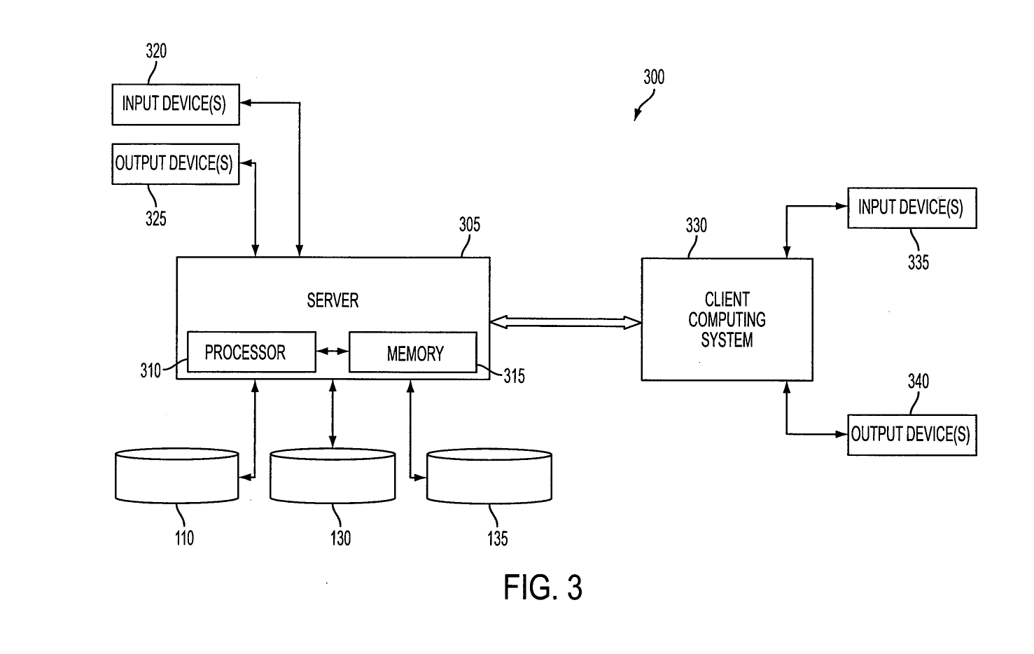

FIG. 3 shows a system 300 according to an embodiment of the present invention. The system 300 may function to schedule an instructional program for a student. The system includes event database 110, student database 130 and rule database 135. Again, although shown as separate databases, one or more of the databases 110, 130 and 135 may be combined in other embodiments. Furthermore, a plurality of databases may be used to implement any of event database 110, student database 130 and rule database 135. The databases 110, 130 and 135 are in communication with a server system 305. Any communication medium may be used, wired or wireless, and any communication protocols employed. The server system 305 includes processor 310 and memory 315. The memory 315 may be encoded with computer readable instructions that cause the processor 310 to perform the computer implemented method 127 described above. One or more input devices 320 and output devices 325 may be coupled to the server system 305. Input and output devices may include, for example, keyboards, displays, mice, further storage units and the like. Input and output devices 320 and 325 may be used, for example, to initialize the databases 110, 130 and 135, including in some embodiments, storing events in the event database 110 or rules in the rule database 135, or both.

The server system 305 is coupled for communication with a client computing system 330. Any communication mechanism may be used, and the server system 305 may be in communication with a plurality of client computing systems in some embodiments. For example, the server system 305 may communicate with one or more client computing systems over the Internet to perform scheduling functionality described above. The client computing system 330 is coupled to input and output devices 335, 340 which may include keyboards, displays, mice, further storage or the like. The client computing system 330 may further include a processor and memory. The client computing system 330 generally receives data from the server system 305 and displays relevant scheduling information for a student, as described above. For example, an output device 340 may include a monitor configured to display scheduling choices, such as the browser shown in FIG. 2.

From the foregoing it will be appreciated that, although specific embodiments of the invention have been described herein for purposes of illustration, various modifications may be made without deviating from the spirit and scope of the invention. Embodiments of the invention may be implemented in hardware, software, or combinations thereof.

What is claimed is:

1. A computer-implemented method for scheduling an instructional course for a student, the instructional course requiring completion of a plurality of events in accordance with at least one rule associated with a regulatory authority, the method comprising:
receiving a scheduling request for a student associated with a first regulatory authority;
accessing a rule database to identify the at least one rule associated with the first regulatory authority;
accessing an event database containing a plurality of events;
displaying a first set of events of the plurality of events complying with the at least one rule and including an indication of events complying with the at least one rule;
receiving a request to schedule the student into at least one of the first set of compliant events; and
associating the requested event with an account associated with the student in a student database.

2. The computer-implemented method of claim 1 wherein the plurality of events includes at least one of a classroom, laboratory, observation, or simulation session.

3. The computer-implemented method of claim 1 further comprising:
displaying a second set of events of the plurality of events complying with at least one rule associated with the course and including an indication of events complying with the at least one rule, wherein the second set of events is different from the first set of events based on the request to schedule the student into the at least one of the first set of compliant events; and
receiving a request to schedule the student into at least one of the second set of compliant events.

4. The computer-implemented method of claim 1 further comprising:
updating a stored student record associated with the student after completion of the at least one of the first set of compliant events to reflect the completion.

5. The computer-implemented method of claim 4 further comprising:
updating the stored student record after completion of the at least one of the second set of compliant events; and
transmitting compliance information regarding the student to an entity associated with the first regulatory authority.

6. The computer-implemented method of claim 5 wherein the compliance information includes at least a portion of the stored student record.

7. The computer-implemented method of claim 1 further comprising:
storing the plurality of events in the event database, each of the plurality of events respectively associated with at least one required resource, each of the stored plurality of events reflecting availability of the respective at least one required resource.

8. The computer-implemented method of claim 7 wherein the respective at least one required resource is selected from a group of resources including an instructor, a vehicle, and a location.

9. The computer-implemented method of claim 1 further comprising:
receiving a request to reschedule the at least one event of the first set of compliant events; and
transmitting instructions for display of a second set of events of the plurality of events complying with the at least one rule and including an indication of events complying with the at least one rule, wherein the second set of events is different from the first set of events based on the request to reschedule.

10. The computer-implemented method of claim 1 further comprising:
storing a plurality of student identifiers in a student database, each of the student identifiers associated with a respective student and stored student account.

11. The computer-implemented method of claim 1 further comprising:
receiving a scheduling request for a second student associated with a second regulatory authority;
accessing the rule database to identify at least one rule associated with the second regulatory authority;
accessing the event database containing the plurality of events; and
transmitting instructions for display of a second set of events of the plurality of events complying with the at least one rule associated with the second regulatory authority, the third set of events different from the first set of events based at least in part on the second regulatory authority and including an indication of events complying with the at least one rule associated with the second regulatory authority.

12. A computer program product for scheduling an instructional course for a student, the instructional course requiring completion of a plurality of events in accordance with at least one rule associated with a regulatory authority, the computer program product comprising a computer readable medium encoded with a plurality of instructions that, when executed, cause a processor to:
receive a scheduling request for a student associated with a first regulatory authority;
access a rule database to identify the at least one rule associated with the first jurisdiction;
access an event database containing a plurality of events;
transmit instructions for display of a first set of events of the plurality of events complying with the at least one rule and including an indication of events complying with the at least one rule;
receive a request to schedule the student into at least one of the first set of compliant events; and
associate the requested event with an account associated with the student in a student database.

13. A system for scheduling an instructional course for a student, the instructional course requiring completion of a plurality of events in accordance with at least one rule associated with a regulatory authority, the system comprising:
a rule database;
an event database;
a server coupled to the rule and event databases and including a processor coupled to a computer readable medium, the computer readable medium including instructions that, when executed, cause the processor to:
receive a scheduling request for a student associated with a first regulatory authority;
access the rule database to identify the at least one rule associated with the first jurisdiction;
access the event database;
transmit instructions for display of a first set of events of the plurality of events complying with the at least one rule and including an indication of events complying with the at least one rule;
receive a request to schedule the student into at least one of the first set of compliant events; and
associate the requested event with an account associated with the student in a student database.

14. The system of claim 13 wherein the instructions further include instructions causing the processor to:
transmit instructions for display of a second set of events of the plurality of events complying with the at least one rule and including an indication of events complying with the at least one rule, wherein the second set of events is different from the first set of events based on the request to schedule the student into the at least one of the first set of compliant events; and
receive a request to schedule the student into at least one of the second set of compliant events.

15. The system of claim 13 further comprising a transmission medium coupled to the server and configured to transmit the instructions for display of the first set of events.

16. The system of claim 13 further comprising:
a student database storing a plurality of student identifiers at least one of which is associated with the student, each of the plurality of student identifiers associated with a respective stored student account.

17. The system of claim 16 wherein the instructions further comprise instructions causing the processor to:
update a stored student account associated with the student after completion of the at least one of the first set of compliant events to reflect the completion.

18. The system of claim 17 wherein the instructions further comprise instructions causing the processor to:
update the stored student account after completion of the at least one of the second set of compliant events; and
transmit compliance information regarding the student to an entity associated with the first regulatory authority.

19. The system of claim 13 wherein each of the plurality of events is respectively associated with at least one required resource, each of the stored plurality of events reflecting availability of the respective at least one required resource.

20. The system of claim 13 wherein the instructions further comprise instructions causing the processor to:
receive a request to reschedule the at least one event of the first set of compliant events; and
transmit instructions for display of a second set of events of the plurality of events complying with the at least one rule and including an indication of events complying with the at least one rule, wherein the second set of events is different from the first set of events based on the request to reschedule.

21. The system of claim 13 wherein the instructions further comprise instructions causing the processor to:
receive a scheduling request for a second student associated with a second regulatory authority;
access the rule database to identify at least one rule associated with the second regulatory authority;
access the event database containing the plurality of events; and
transmit instructions for display of a second set of events of the plurality of events complying with the at least one rule associated with the second regulatory authority, the second set of events different from the first set of events based at least in part on the second regulatory authority and including an indication of events complying with the at least one rule associated with the second regulatory authority.

22. A computer-implemented method for scheduling an instructional course for a student, the instructional course requiring completion of a plurality of events in accordance with at least one rule associated with a regulatory authority, the method comprising:
transmitting a scheduling request for a student associated with a first regulatory authority;
receiving instructions for display of a first set of events of the plurality of events complying with the at least one rule associated with the first regulatory authority and an indication of events complying with the at least one rule;
displaying the first set of events of the plurality of events and the indication of events complying with the at least one rule; and
transmitting a request to schedule the student into the at least one of the first set of events.

23. The computer-implemented method of claim 22 further comprising:
transmitting a student identifier associated with the student.

24. The computer-implemented method of claim 22 further comprising:
displaying a second set of events of the plurality of events complying with at least one rule associated with the course and including an indication of events complying with the at least one rule, wherein the second set of events is different from the first set of events based on the request to schedule the student into the at least one of the first set of compliant events; and
transmitting a request to schedule the student into at least one of the second set of compliant events.

25. The computer-implemented method of claim 22 further comprising:
transmitting information regarding completion of the at least one of the first set of compliant events, at least in part causing a stored student record associated with the student to be updated to reflect the completion.

26. The computer-implemented method of claim 22 further comprising:
transmitting a request to reschedule the at least one event of the first set of compliant events; and
displaying a second set of events of the plurality of events complying with the at least one rule and an indication of events complying with the at least one rule, wherein the second set of events is different from the first set of events based on the request to reschedule.
